(19) United States
(12) Patent Application Publication
(10) Pub. No.: US 2023/0158979 A1
(43) Pub. Date: May 25, 2023

(54) ASSEMBLY FOR A VEHICLE COMPRISING A PLURALITY OF BATTERIES AND AN EVACUATION SYSTEM

(71) Applicants: Airbus Operations SAS, Toulouse (FR); Airbus Operations S.L., Getafe (ES)

(72) Inventors: Gabrielle Josephine Christiane DE BROUWER, GETAFE (ES); Bernardo ARMERO, TOULOUSE (FR)

(21) Appl. No.: 17/991,979

(22) Filed: Nov. 22, 2022

(30) Foreign Application Priority Data
Nov. 25, 2021 (FR) 2112507

(51) Int. Cl. B60R 16/04; H01M 50/342; H01M 50/317; H01M 10/42; H01M 10/52

(52) U.S. Cl. CPC B60R 16/04; H01M 50/3425; H01M 50/317; H01M 10/4257; H01M 10/52; H01M 2220/20

(57) ABSTRACT

An assembly for a vehicle comprising at least two battery blocks, each having a casing in which the battery block is enclosed and that has a connection face. The outer skin of the vehicle has an outlet orifice. There is a main duct connected to the outlet orifice. For each casing, an evacuation duct is connected between the connection face and the main duct. A damping unit is provided at the joint between each connection face and the evacuation duct. A damping unit is provided at the joint between the main duct and the outlet orifice. Each damping unit limits the amplitude of an overpressure propagating from the casing towards the outlet orifice. Such an assembly enables an overpressure to be damped in the event of a battery being damaged, inter alia.

### CROSS-REFERENCES TO RELATED APPLICATIONS

This application claims the benefit of the French patent application No. 2112507 filed on Nov. 25, 2021, the entire disclosures of which are incorporated herein by way of reference.

### FIELD OF THE INVENTION

The present invention relates to an assembly for a vehicle, in particular an aircraft, in which the assembly comprises a plurality of batteries and an evacuation system arranged to evacuate fluids away from the vehicle. The invention also relates to a vehicle fitted with such an assembly.

### BACKGROUND OF THE INVENTION

An aircraft conventionally includes batteries, in particular lithium-ion batteries, to supply electricity to the apparatuses on the aircraft.

FIG. 7 shows an installation according to the prior art. The installation has two battery blocks 102a-b, each of which comprises at least one battery, and each battery block 102a-b is contained in an enclosure 104a-b delimited by a wall that confines the battery block 102a-b in the event of failure of one of the batteries in the battery block 102a-b.

If a battery is damaged, gases can propagate inside the enclosure 104a-b. To evacuate these gases, the aircraft has an evacuation system 110 to evacuate the gases to outside the aircraft.

The evacuation system 110 is provided for two battery blocks 102a-b and includes an outlet orifice 106 that is arranged in the skin 108 of the aircraft, a T-fitting 114, and, for each battery block 102a-b, an evacuation duct 112a-b that is fluidly connected between the associated enclosure 104a-b and one of the inlets of the T-fitting 114.

The evacuation system 110 also includes an output duct 118 fluidly connected between an outlet of the T-fitting 114 and the outlet orifice 106.

The T-fitting 114 is fitted with a check valve 116, in this case in the form of a ball that moves between the two inlets of the T-fitting 114 as a function of the pressure in each evacuation duct 112a-b to close the inlets alternately, thereby enabling gas to flow from one evacuation duct 112a-b to the outlet orifice 106.

Consequently, in the event of a problem with the battery block 102a, the pressurized gas flows through the evacuation duct 112a and pushes the ball against the other evacuation duct 112b to close the duct and to prevent the fluid from flowing towards the battery block 102b. The gas then proceeds through the output duct 118 to the outlet orifice 106.

If a battery is damaged, the battery can generate an overpressure that propagates through the ducts 112a-b and 118 and the T-fitting 114. To withstand this overpressure, the ducts 112a-b and 118 have to be relatively strong. To ensure this strength, the ducts are made of metal, which makes the evacuation system 110 relatively heavy, and this has a negative effect on aircraft fuel consumption.

Furthermore, where a ball is used, means preventing the ball from being jammed by freezing are required, which makes the evacuation system 110 even heavier.

### SUMMARY OF THE INVENTION

One objective of the present invention is to propose an assembly for a vehicle, in particular an aircraft, in which the assembly comprises a plurality of batteries and an evacuation system arranged to evacuate fluids away from the vehicle, and in which this evacuation system is lighter than in the prior art.

For this purpose, an assembly for a vehicle is proposed, the assembly comprising:
at least two battery blocks, each of which comprises at least one battery,
for each battery block, a casing in which the battery block is enclosed and that has a connection face,
an outlet orifice arranged through an outer skin of the vehicle,
a main duct fluidly connected to the outlet orifice,
for each casing, an evacuation duct fluidly connected between the connection face of the casing and the main duct, and
a damping unit of a first type at the joint between each connection face and the associated evacuation duct and a damping unit of a second type at the joint between the main duct and the outlet orifice, in which each damping unit is designed to limit the amplitude of an overpressure propagating from the casing towards the outlet orifice,

wherein the assembly includes, associated with each casing, an enclosure delimited by a wall and in which the casing and the damping unit of the first type associated with the casing are seated, and wherein each evacuation duct is fluidly connected to the associated connection face through the wall of the corresponding enclosure, wherein each damping unit of the first type has a weakened zone made in the connection face of the casing, a chassis fastened sealingly between the evacuation duct and the connection face of the casing and including a window that passes through the chassis and faces the weakened zone, and a shutter mounted on the chassis that is moveable alternately between a closed position in which the shutter closes the window and an open position in which the shutter does not close the window, an actuator arranged to move the shutter from the open position to the closed position and vice versa, wherein each enclosure is fitted with a pressure sensor and a temperature sensor provided to measure the pressure and the temperature inside the enclosure, and the assembly has a control unit arranged to receive the measurements sent by the pressure sensors and the temperature sensors and to control each actuator.

Such an assembly enables an overpressure to be damped in the event of a battery being damaged, inter alia.

Advantageously, each enclosure has a temperature sensor provided to measure the temperature inside the enclosure, the assembly has a tank containing a pressurized inert gas, a network of overflow ducts with one end fluidly connected to the tank through an origin solenoid valve, for each enclosure, one end fluidly connected to the enclosure through a destination solenoid valve, and one end fluidly connected to the main duct through a destination solenoid valve, and a secondary control unit arranged to receive the measurements sent by the temperature sensors and to command each solenoid valve to close or to open.

The invention also proposes an aircraft including an outer skin and at least one assembly according to one of the preceding variants.

### BRIEF DESCRIPTION OF THE DRAWINGS

The aforementioned and other features of the present invention are set out more clearly in the description given below of an example embodiment, the description being provided with reference to the attached drawings, in which:

FIG. 1 is a side view of an aircraft according to the invention,

FIG. 2 is a schematic view of an assembly according to a first embodiment of the invention,

FIG. 3 is a schematic view of an assembly according to a second embodiment of the invention,

FIG. 4 is a cross-section view of a damping unit according to a first embodiment of the invention,

FIG. 5 is a cross-section view of a damping unit according to a second embodiment of the invention,

FIG. 6 is a cross-section view of a damping unit according to a third embodiment of the invention, and

FIG. 7 is a schematic view of an assembly according to the prior art.

### DETAILED DESCRIPTION OF THE PREFERRED EMBODIMENTS

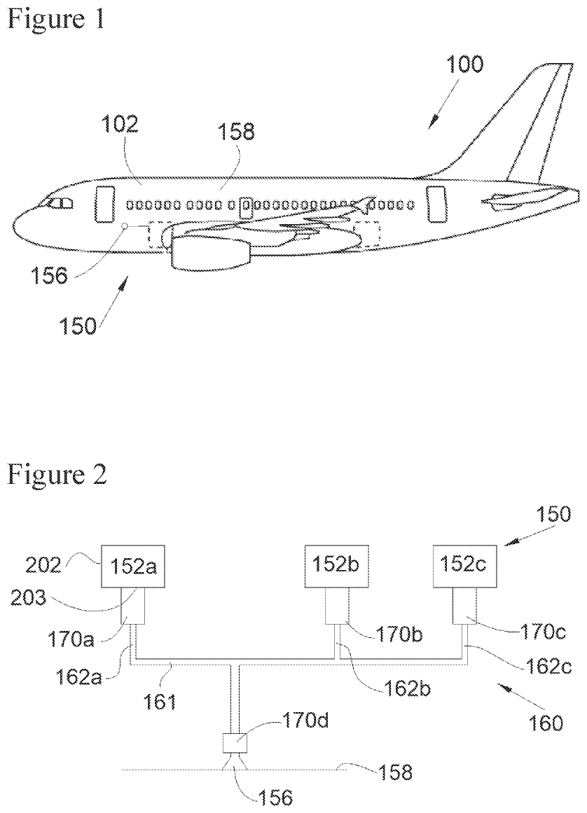

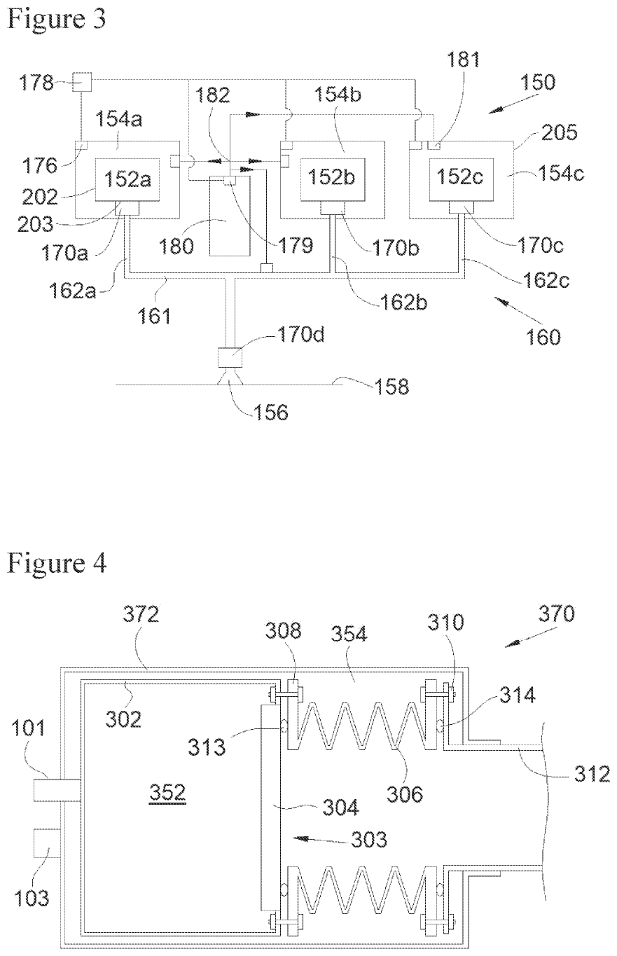

FIG. 1 shows an aircraft 100 that comprises a fuselage 102 with an outer skin 158, inside which is fastened an assembly 150 according to the invention, as shown schematically in FIG. 2 for a first embodiment of the invention and in FIG. 3 for a second embodiment of the invention. Although the invention is described more specifically for an aircraft, it can be applied to any vehicle carrying battery blocks in operation.

In the first embodiment of the invention, the assembly 150 comprises a plurality of battery blocks 152a-c and each battery block 152a-c is enclosed in a casing 202 that confines the battery block 152a-c and has a connection face 203. In the embodiment of the invention shown in FIGS. 2 and 3, there are three battery blocks 152a-c, but the invention can be implemented using at least two battery blocks 152a-c.

Each battery block 152a-c has at least one battery, in particular a lithium-ion battery. These batteries are intended to power the electrical apparatuses of the aircraft 100 via electrical conductors (not shown) running between the batteries and the electrical apparatuses.

The assembly 150 also has an evacuation system 160 that has an outlet orifice 156 that is arranged through the outer skin 158 of the aircraft 100, a main duct 161 fluidly connected to the outlet orifice 156, and, for each casing 202, an evacuation duct 162a-c fluidly connected between the connection face 203 of the associated casing 202 and the main duct 161 and via this latter to the outlet orifice 156.

Consequently, in the event of a problem with a battery block 152a-c, the pressurized gas flows through the corresponding evacuation duct 162a-c to the main duct 161 and the outlet orifice 156.

Depending on the problem with the battery block 152a-c, an overpressure may be caused. This overpressure can then propagate through the evacuation ducts 162a-c and the main duct 161.

To prevent such an overpressure from propagating, the evacuation system 160 includes a damping unit 170a-c of a first type at the joint between each connection face 203 and the associated evacuation duct 162a-c and a damping unit 170d of a second type at the joint between the main duct 161 and the outlet orifice 156.

Each damping unit 170a-d is provided to limit the amplitude of the overpressure propagating from the casing 202 towards the outlet orifice 156 in the evacuation system 160, and heavy rigid ducts are no longer required, allowing lighter ducts to be used.

The evacuation system 160 according to the invention no longer requires a T-fitting with a check valve system, enabling a simpler installation requiring less maintenance to be used. More than two battery blocks 152a-c can also be installed.

Each damping unit 170a-c of the first type associated with a casing 202 enables any overpressure coming out of the casing 202 through the connection face 203 towards the outlet orifice 156 to be attenuated, and performs the function of a check valve if an overpressure is generated from another casing 202.

If a battery is damaged and generates an overpressure, the corresponding damping unit 170a of the first type dampens the overpressure propagating through the corresponding evacuation duct 162a and the main duct 161, and if the overpressure reaching the main duct 161 is still relatively powerful, the damping unit 170d of the second type at the outlet orifice 156 dampens the overpressure before the overpressure is discharged to the outside.

In the second embodiment of the invention, each casing 202 is seated in an enclosure 154a-c delimited by a wall 205 that confines the battery block 152a-c enclosed in the casing 202 and the damping unit 170a-c of the first type associated with the casing 202.

Each evacuation duct 162a-c is fluidly connected to the connection face 203 of the corresponding casing 202 through the wall 205 of the associated enclosure 154a-c.

FIGS. 4 to 6 show different embodiments of a damping unit 370, 470, 570. Each of FIGS. 4 to 6 shows a damping unit 370, 470, 570 of the first type at the joint between a connection face 303, 403, 503 of the casing 302, 402, 502 and the associated evacuation duct 312, 412, 512. Naturally, each damping unit 370, 470, 570 of the first type can adopt one or other of the different proposed forms.

In each of the embodiments, the casing 302, 402, 502 is fastened to the structure of the aircraft 100. Where the casing 302, 402, 502 is in an enclosure 354, 454, 554, the wall 372, 472, 572 of the enclosure 354, 454, 554 is also fastened to the structure of the aircraft 100 using first fastening means 103.

The casing 302, 402, 502 can then be fastened to the wall 372, 472, 572 of the enclosure 354, 454, 554 or directly to the structure of the aircraft 100 using fastening means 101, regardless of whether the casing 302, 402, 502 is seated in an enclosure 354, 454, 554 or otherwise.

In the embodiment shown in FIG. 4, the damping unit 370 of the first type includes a rupture disk 304 forming the connection face 303 of the casing 302 in which the battery block 352 is enclosed. The rupture disk 304 is a wall that is designed to break when the pressure exerted on the disk reached a predetermined threshold, and that has a mechanical strength value below the mechanical strength of the other faces of the casing 302 to ensure that the rupture disk 304 breaks before the other faces.

The damping unit 370 of the first type also has bellows 306 having a first end fastened sealingly to the casing 302 about the rupture disk 304 and a second end fastened sealingly to the inlet of the evacuation duct 312. Consequently, if an overpressure is generated in the battery block 352, the overpressure breaks the rupture disk 304, which reduces the amplitude thereof and the bellows 306 are inflated under the effect of the overpressure, which also reduces the amplitude.

In the second embodiment, to confine the overpressure, for example in the event of the bellows 306 breaking, the wall 372 of the enclosure 354 encloses the battery block 352, the casing 302 thereof, the inlet of the evacuation duct 312 and the bellows 306.

In the embodiment of the invention shown in FIG. 4, the bellows 306 have a skirt 308 at each end to fasten the bellows, the skirt in this case being fastened using nuts 310 about the skirt 308 respectively to the casing 302 or to the evacuation duct 312. To complete the seal, a ring gasket 313 is clamped between the skirt 308 and the casing 302 and a ring gasket 314 is clamped between the skirt 308 and the evacuation duct 312.

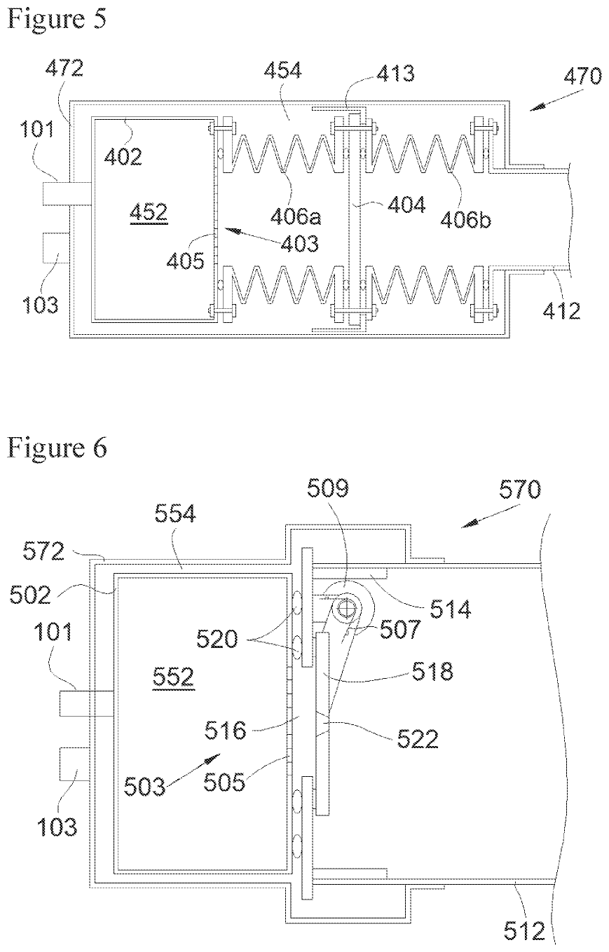

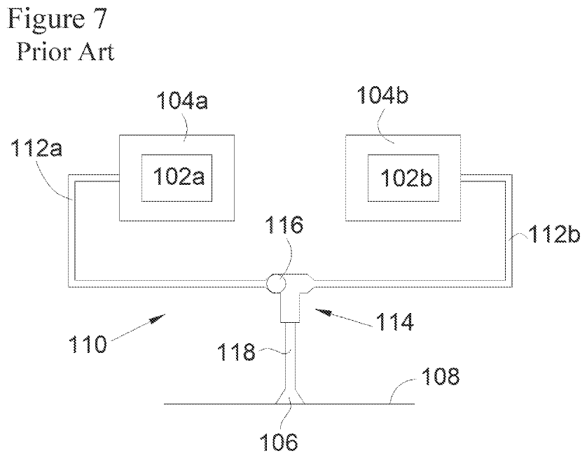

In the embodiment shown in FIG. 5, the damping unit 470 of the first type includes a weakened zone 405 made in the connection face 403 of the casing 402 in which the battery block 452 is enclosed. The weakened zone 405 is, for example, an orifice or a pre-cut zone or a zone of lesser thickness than the other faces of the casing 402. In general, the weakened zone 405 has a mechanical strength value below the mechanical strength of the other faces of the casing 402.

The damping unit 470 of the first type also has a rupture disk 404 that is fastened between the connection face 403 of the casing 402 and the inlet of the evacuation duct 412. To do so, the damping unit 470 has a chassis 413 against which the rupture disk 404 is held. The chassis 413 is fastened to the structure of the aircraft 100 or to the wall 472 of the enclosure 454 where present.

The damping unit 470 of the first type also has first bellows 406a with a first end fastened sealingly to the casing 402 about the weakened zone 405 and a second end fastened sealingly to a first face of the rupture disk 404, and second bellows 406b with a first end fastened sealingly to a second face of the rupture disk 404 and a second end fastened sealingly to the inlet of the evacuation duct 412. The two faces of the rupture disk 404 are opposite one another.

Consequently, if an overpressure is generated in the battery block 452, the overpressure breaks the rupture disk 404, which reduces the amplitude thereof and the bellows 406a-b are inflated under the effect of the overpressure, which also reduces the amplitude.

In the second embodiment, to confine the overpressure, for example in the event of the bellows 406a-b breaking, the wall 472 of the enclosure 454 encloses the battery block 452, the casing 402 thereof, the inlet of the evacuation duct 412, the rupture disk 404 and the bellows 406a-b.

In the embodiment of the invention shown in FIG. 5, each of the bellows 406 has a skirt at each end to fasten the bellows, the skirt in this case being fastened using nuts about the skirt, to the rupture disk 404 and to the casing 402 or to the evacuation duct 412. To complete the seal, a ring gasket is clamped between each skirt and the corresponding counterpart.

In the embodiment shown in FIG. 6, the damping unit 570 of the first type includes a weakened zone 505 made in the connection face 503 of the casing 502 in which the battery block 552 is enclosed. The weakened zone 505 is, for example, an orifice or a pre-cut zone or a zone of lesser thickness than the other faces of the casing 502. In general, the weakened zone 505 has a mechanical strength value below the mechanical strength of the other faces of the casing 502.

The damping unit 570 of the first type also has a chassis 514 that is fastened sealingly between the evacuation duct 512 and the connection face 503 of the casing 502. In the embodiment of the invention shown in FIG. 6, the chassis 514 is fastened and fitted inside the inlet of the evacuation duct 512.

In this case, the fastening is sealed by two ring gaskets 520 fastened between the chassis 514 and the casing 502.

The chassis 514 has a window 516 traversing the chassis and a shutter 518 that is mounted on the chassis 514 and that is moveable alternately between a closed position in which the shutter 518 closes the window 516 and an open position in which the shutter 518 does not close the window 516. The window 516 faces the weakened zone 505.

To prevent the untimely opening of the shutter 518, the damping unit 570 also has return means 507, such as a spring, that constrain the shutter 518 in the closed position. The force exerted by the return means 507 should be enough to hold the shutter 518 in the closed position, but should not prevent the shutter 518 from opening when the pressure exerted on the shutter 518 exceeds a threshold.

In the embodiment of the invention shown in FIG. 6, the shutter 518 is mounted movably in rotation and opens towards the evacuation duct 512 and the return means 507 are for example a torsion spring.

Consequently, if an overpressure is generated in the battery block 552, the overpressure pushes the shutter 518 towards the open position to open the window 516, which reduces the amplitude of the overpressure.

In the second embodiment, to confine the overpressure in the event of a leak from the ring gaskets 520, the wall 572 of the enclosure 554 encloses the battery block 552, the casing 502 thereof, the inlet of the evacuation duct 512, the chassis 514, and the shutter 518.

There is a hole 522, for example with a diameter in the order of 1 mm to 2 mm, in the shutter 518 to balance the pressure on each side thereof.

The different embodiments described with reference to FIGS. 4 to 6 are associated with a damping unit of the first type. For a damping unit of the second type, the outlet of the evacuation duct 312, 412, 512 is used in place of the casing 302, 402, 502 and the outlet orifice 156 is used in place of the evacuation duct 312, 412, 512. The rupture disk or the shutter are then provided at the outlet of the evacuation duct 312, 412, 512 and the bellows, where present, are provided between the outlet of the evacuation duct 312, 412, 512 and the outlet orifice 156.

The embodiments shown in FIGS. 4 to 6 are passive damping units, but active damping units can also be used.

In the embodiment shown in FIG. 6, the return means 507 are replaced by an actuator 509, for example a motor or a jack, that is arranged to move the shutter 518 from the open position to the closed position and vice versa.

The assembly 150 also includes a control unit 178 that, for example, includes the following, linked by a communication bus: a central processing unit (CPU), a random access memory (RAM), a read-only memory (ROM), a storage unit such as a hard disk or a storage medium reader such as a secure digital (SD) card reader, and at least one communication interface enabling, for example, the control unit 178 to communicate with each actuator 509, inter alia.

The processor is able to execute instructions loaded into the RAM from the ROM, an external memory (not shown), a storage medium (such as an SD card), or a communication network. When the equipment is powered up, the processor is able to read the instructions from the RAM and to execute the instructions. These instructions form a computer program causing the processor to implement some or all of the algorithms and steps described below.

Some or all of the algorithms and steps described below can be implemented in software form by executing a set of instructions using a programmable machine, such as a digital signal processor (DSP) or a microcontroller, or be implemented in hardware form using a dedicated component or machine, for example a field-programmable gate array (FPGA) or an application-specific integrated circuit (ASIC).

Each enclosure 154a-c is fitted with a sensor system 176 with a pressure sensor and a temperature sensor provided to measure the pressure and the temperature inside the enclosure 154a-c, and the control unit 178 is arranged to receive the measurements sent by the pressure sensors and the temperature sensors.

The control unit 178 uses this information to determine whether or not there is a problem in one of the enclosures 154a-c. Accordingly, there is a problem in an enclosure 154a-c if the temperature and/or the pressure in the enclosure 154a-c exceed predetermined thresholds, and there is no problem in the enclosure 154a-c if neither the temperature nor the pressure inside the enclosure 154a-c has exceeded the predetermined thresholds.

According to one specific embodiment, each enclosure 154a-c is fitted with such a damping unit of the first type. In normal operation, i.e., when no problem has been detected, the control unit 178 commands the actuator 509 associated with each enclosure 154a-c to position the associated shutter 518 in the open position, and when a problem is detected in an enclosure 154a-c, the control unit 178 commands each actuator 509 corresponding to an enclosure 154a-c where no problem has been detected to position the corresponding shutter 518 in the closed position. Consequently, if a problem is detected in an enclosure 154a-c, the shutters 518 corresponding to the other enclosures 154a-c are closed to prevent propagation to the healthy enclosures 154a-c and to reduce the amplitude of the overpressure.

According to another specific embodiment, each enclosure 154a-c is fitted with such a damping unit of the first type. In normal operation, the control unit 178 commands the actuator 509 of each enclosure 154a-c to position the associated shutter 518 in the closed position, and when a problem is detected in an enclosure 154a-c, the control unit 178 commands the actuator 509 corresponding to the enclosure 154a-c to position the corresponding shutter 518 in the open position. Consequently, if a problem is detected in an enclosure 154a-c, the shutter 518 corresponding to the enclosure 154a-c is opened to reduce the amplitude of the overpressure.

According to one specific embodiment, the assembly 150 has a tank 180 containing a pressurized inert gas, and a network of overflow ducts 182 with one end fluidly connected to the tank 180 through an origin solenoid valve 179, for each enclosure 154a-c, one end fluidly connected to the enclosure 154a-c, and one end fluidly connected to the main duct 161.

For each enclosure 154a-c and for the main duct 161, the assembly 150 also has a destination solenoid valve 181 that is mounted at the end fluidly connected to the enclosure 154a-c or to the main duct 161 respectively.

Consequently, when the origin solenoid valve 179 is open, the inert gas spreads through the network of overflow ducts 182 and, depending on which destination solenoid valve 181 is open, the inert gas spreads into the enclosure 154a-c or the main duct 161 respectively and the evacuation duct 162a-c when the inert gas spreads through the main duct 161.

This embodiment can be implemented with either of the active or passive embodiments described above.

The assembly 150 also has a secondary control unit that can be the same as described above or of another of the same type in communication therewith. In the embodiment of the invention shown in FIG. 3, the secondary control unit is considered to be the control unit 178.

As in the active embodiments, each enclosure 154a-c includes a sensor system 176 with a temperature sensor provided to measure the temperature inside the enclosure 154a-c, and the secondary control unit 178 is arranged to receive the measurements sent by each temperature sensor and to command the origin solenoid valve 179 to open or close alternately and to command each destination solenoid valve 181 to open or close. As before, the secondary control unit 178 determines whether or not there is a problem in one of the enclosures 154a-c. Accordingly, there is a problem in an enclosure 154a-c if the temperature exceeds a predetermined threshold, and there is no problem if the temperature has not exceeded the predetermined threshold.

In normal operation, the secondary control unit 178 commands the origin solenoid valve 179 to close, thereby preventing the inert gas from flowing into the enclosures 154a-c and the main duct 161.

If a problem is detected in an enclosure 154a-c, the secondary control unit 178 commands the origin solenoid valve 179 to open, which enables the inert gas to flow through the network of overflow ducts 182, and the secondary control unit 178 commands the destination solenoid valve 181 corresponding to each enclosure 154 with a problem to open, and the destination solenoid valves 181 of the other enclosures 154a-c and of the main duct 161 to close.

This injection of inert gas helps to reduce overheating and to prevent any flames from forming in the enclosure 154a-c where the problem has been detected.

Furthermore, each destination solenoid valve 181 is preferably a check valve to prevent the inert gas or overpressure gas from spreading from the enclosure 154a-c to the tank 180.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An assembly for a vehicle, said assembly comprising:
at least two battery blocks, each of which comprises at least one battery,
for each battery block, a casing in which said battery block is enclosed and that has a connection face,
an outlet orifice arranged through an outer skin of the vehicle,
a main duct fluidly connected to the outlet orifice,
for each casing, an evacuation duct fluidly connected between the connection face of said casing and the main duct, and
a damping unit of a first type at the joint between each connection face and the associated evacuation duct and a damping unit of a second type at a joint between the main duct and the outlet orifice, in which each damping unit is configured to limit an amplitude of an overpressure propagating from said casing towards said outlet orifice,
wherein the assembly includes, associated with each casing, an enclosure delimited by a wall and wherein said casing and the damping unit of the first type associated with said casing are seated, and wherein each evacuation duct is fluidly connected to the associated connection face through the wall of the corresponding enclosure,
wherein each damping unit of the first type has
a weakened zone made in the connection face of the casing,
a chassis fastened sealingly between the evacuation duct and the connection face of the casing and including a window that passes through said chassis and faces the weakened zone,
a shutter mounted on the chassis that is moveable alternately between a closed position in which the shutter closes the window and an open position in which the shutter does not close the window,
an actuator arranged to move the shutter from the open position to the closed position and vice versa,
wherein each enclosure is fitted with a pressure sensor and a temperature sensor provided to measure a pressure and a temperature inside said enclosure, and
wherein the assembly has a controller arranged to receive measurements sent by the pressure sensors and the temperature sensors and to control each actuator.

2. The assembly according to claim 1,
wherein each enclosure has a temperature sensor provided to measure the temperature inside said enclosure,
wherein the assembly has a tank containing a pressurized inert gas, a network of overflow ducts with one end fluidly connected to the tank through an origin solenoid valve, for each enclosure, one end fluidly connected to said enclosure through a destination solenoid valve, and one end fluidly connected to the main duct through a destination solenoid valve, and a secondary control unit arranged to receive the measurements sent by each temperature sensor and to command each solenoid valve to close or to open.

3. An aircraft including an outer skin and at least one assembly according to claim 1.
